(19) United States
(12) Patent Application Publication
(10) Pub. No.: US 2023/0174247 A1
(43) Pub. Date: Jun. 8, 2023

(54) Adaptive Cooling System For An Aircraft

(71) Applicant: Overair, Inc., Santa Ana, CA (US)

(72) Inventors: Bernard AHYOW, Irvine, CA (US); Edward BARBER, Bakersfield, CA (US); Abraham KAREM, Santa Ana, CA (US)

(21) Appl. No.: 17/920,264

(22) PCT Filed: Apr. 29, 2021
(86) PCT No.: PCT/US2021/029834

§ 371 Date: Oct. 20, 2022

Related U.S. Application Data
(60) Provisional application No. 63/018,762, filed on May 1, 2020.

(51) Int. Cl. B64D 33/08; B64C 29/00; B60L 58/26; H01M 10/6568; H01M 10/613; H01M 10/625

(52) U.S. Cl. CPC B64D 33/08; B64C 29/0033; B60L 58/26; H01M 10/6568; H01M 10/613; H01M 10/625; B60L 2200/10; H01M 2220/20

(57) ABSTRACT

An aircraft nacelle has a first and second heat exchanger section to cool aircraft during different modes. Additionally, a fan and other components are configured to maximize efficiency and cooling capacity during a plurality of operating conditions.

### PRIORITY CLAIM

This application is a national phase of PCT/US21/29834 filed Apr. 29, 2021, which claims priority to U.S. provisional application having Ser. No. 63/018,762 (filed May 1, 2020). These and all other extrinsic material discussed herein are incorporated by reference in their entirety. Where a definition or use of a term in an incorporated reference is inconsistent or contrary to the definition of that term provided herein, the definition of that term provided herein applies and the definition of that term in the reference does not apply.

### FIELD OF THE INVENTION

The field of the invention is aircraft thermal management.

### BACKGROUND

Electric vertical takeoff and landing (eVTOL) aircraft are gaining enormous interest from industry and transportation organizations. Some eVTOL—such as tiltrotor and tiltwing eVTOL aircraft—have the ability to also fly wing-borne, like an airplane, in addition to flying rotor-borne, like a helicopter. The two flight modes have two markedly different system demands including differing cooling requirements.

### BRIEF DESCRIPTION OF THE DRAWINGS

FIG. 1 illustrates an embodiment of an aircraft nacelle and rotor assembly comprising a cooling system.

FIG. 2 illustrates an embodiment of an aircraft nacelle and rotor assembly comprising a cooling system; the assembly is shown in horizontal flight configuration.

FIG. 3 illustrates an aircraft comprising a cooling system.

FIG. 4 illustrates an embodiment of a heat exchanger and fan assembly.

FIG. 5 illustrates a heat exchanger and fan assembly comprising shroud flaps.

FIG. 6 illustrates an embodiment of an aircraft nacelle and rotor assembly comprising a cooling system.

FIG. 7 illustrates an embodiment of an aircraft nacelle and rotor assembly comprising a cooling system.

FIG. 8 illustrates an embodiment of an aircraft nacelle and rotor assembly comprising a cooling system including a thermal management controller.

FIGS. 9A and 9B illustrates aspects of an embodiment of an aircraft cooling system comprising a fan configured to park in an orientation that minimized drag on passing cooling air.

FIGS. 10A and 10B illustrate an embodiment of a fan, heat exchanger and fan shroud assembly that comprises multiple fans.

FIGS. 11A and 11B illustrate an embodiment of a fan, heat exchanger and fan shroud assembly that comprises multiple high solidity fans.

FIGS. 12A and 12B illustrate an embodiment of an aircraft cooling system comprising an air inlet that tilts with the nacelle relative to a wing and a wingborne flight duct.

### DETAILED DESCRIPTION

In some VTOL aircraft, a tradeoff may exist between drag during cruise flight and thermal management system performance during VTOL mode. Some aspects disclosed herein may minimize the tradeoffs.

Streamlined aircraft designs are generally the most aerodynamically efficient. Adding an air inlet—such as a cooling cowl—will tend to increase the drag of the aircraft and thus reduce the aircraft's efficiency. In general, the larger a particular air inlet is, the higher the level of associated drag will be. In an eVTOL aircraft—where efficiency is particularly important—an air inlet will ideally be sized as small as possible to maximize the range of the aircraft. However, a heat exchanger sized for nominal wing-borne cruise flight may be insufficiently sized for cooling during low-speed flight, in particular, while in VTOL flight. Thus, both the air passages and the heat exchangers should ideally be configured to minimize drag while providing sufficient cooling capacity. It should be noted that the heat exchanger thickness could be varied. For a given aircraft, there will be an optimal heat exchanger thickness given drag, weight and cooling capacity; increasing the thickness beyond which will result in a “drag penalty.”

One of the great challenges of creating a successful eVTOL aircraft is designing an aircraft that can operate efficiently in both wing-borne flight and VTOL flight. Because of the lower energy density of current batteries compared to a fuel consuming powerplant, eVTOL aircraft need to be very energy efficient. An important aspect of that capability is the ability to cool the key aircraft components in both modes, while minimizing energy used for cooling.

An eVTOL vehicle may comprise numerous components—powertrain and other—that are critical to cool, including: motors, batteries, inverters, gearboxes, and actuators. An aircraft may have a distinct cooling disadvantage during VTOL flight due to low airflow velocity relative to the aircraft. Vehicles typically gain a cooling advantage with increased relative airflow. For example, a car generating a set amount of heat will typically be easier to cool when it is driving on the highway as opposed to driving at low speeds through the city.

In one aspect, presented herein is an efficient adaptive cooling system that provides ideal cooling and aerodynamic characteristics in both wing-borne flight mode and in VTOL flight mode. The cooling system can provide different volumes of air flow over heat exchangers as well alternative airflow paths over the heat exchangers depending on the flight mode. The system can provide various air paths adaptable for different aircraft operating modes as well as various air flow volumes. The system may change the effective area of heat exchanger used or alternatively use various sections of the heat exchanger during different conditions.

In some embodiments an aircraft nacelle may have multiple closed cooling sub-systems, for example: a first cooling subsystem using an oil to air heat exchanger for cooling motors and gear boxes; and, a second sub-system—for example a glycol-to-air heat exchanger—for cooling batteries and inverters. Additionally, a third system could be used to cool a third set of components, for example direct air cooling could be used to cool the motor inverters.

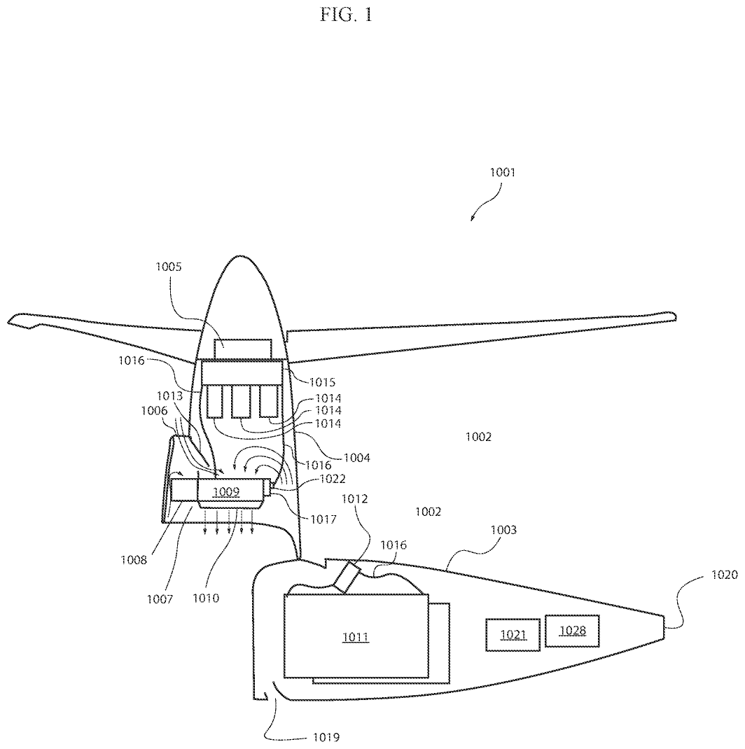

Embodiments such as the one shown in FIG. 1 may be especially beneficial when implemented in an aircraft with relatively low disc loading. Low disc loading VTOL aircraft have relatively low air flow generated from the rotor, for example rotor 1005. Other applications that generate low dynamic pressure over the air inlet may benefit from some of the embodiments or principles presented herein—for example aircraft with propellers characterized by low thrust blade root sections. In such embodiments, the air flow of the rotor's wake will be relatively minimal compared to the airflow through cowl 1006 while the aircraft is travelling forward at cruise speeds. For example, in some applications the velocity of air approaching cowl 1006 during VTOL flight may be merely one-tenth the velocity of air approaching the cowl 1006 during wing-borne flight. As such the dynamic pressure—which goes as the square of airspeed—will be dramatically less during VTOL flight. Thus, the cooling potential of first heat exchanger section 1008 may be greatly diminished during VTOL flight—just when the motors and gear reduction system may need the highest level of cooling.

In applications such as tiltrotor eVTOL aircraft, the benefit of a cooling system that is adaptative and efficient may be exceedingly beneficial.

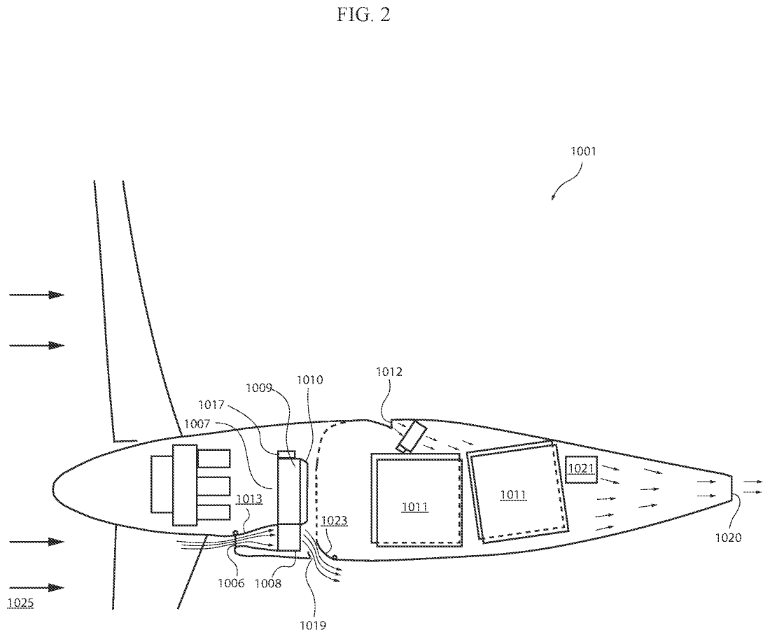

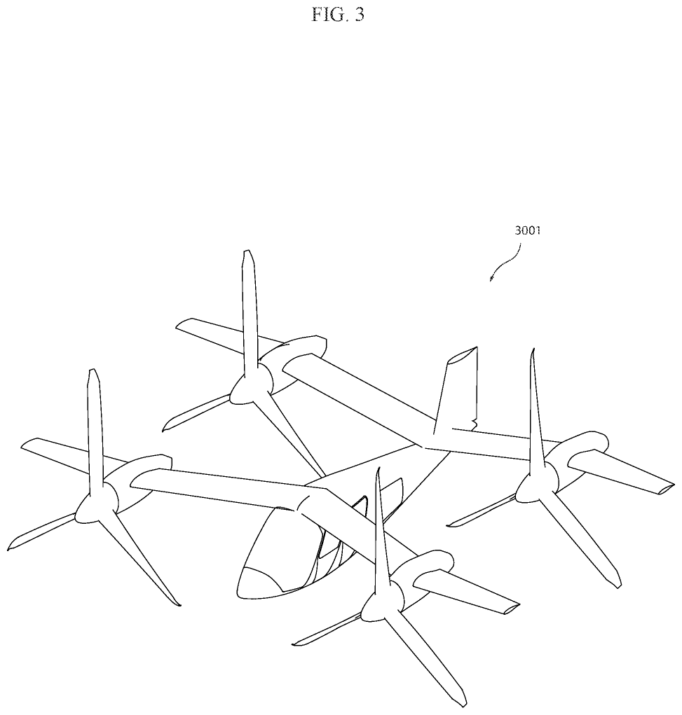

For example, an aircraft, such as aircraft 3001, shown in FIG. 3, may have a nacelle, such as nacelle 1002—shown in FIG. 1. The nacelle may have a first air inlet such as cowl 1006—shown in FIG. 2. Cowl 1006 may be configured to direct air through a first heat exchanger section 1008. The air may exhaust out of the nacelle. The air may exhaust out a first air outlet, such as second cowl 1019. The air may exhaust out aft air vent 1020.

In one embodiment, such as the one illustrated in FIG. 1, an aircraft has a structure, such as nacelle 1002. The structure may have a tilting section 1004 and a fixed section 1003. When the aircraft is operating in VTOL mode, the tilting section 1004 may be in a substantially vertical orientation. Thus, tilting section 1004 will be at an angle relative to the fixed section 1003. When the aircraft, such as aircraft 3001—shown in FIG. 3—is operating in VTOL mode, cooling system 1001 may be configured such that the fan assembly 1010 may provide a significant portion of the air movement. For example, fan assembly 1010 may pull air from the forward section of tilting nacelle section 1004 and push air out the bottom of tilting nacelle section 1004. In low disc loading implementations, there may be significant challenges to achieving significant airflow through heat exchanger 1007. Airflow may be relatively stagnant without fan assembly 1010. In such an embodiment, air may flow through a second inlet, for example the periphery of the tilting nacelle section opening through the second heat exchanger section 1009. The air may then vent out of the bottom of the tilting section. In VTOL mode, the opening through which the air vents may be substantially larger than the vent passage cross section used during forward wing-borne flight.

Thus, both the inlet passages and vent air passages may be significantly larger in VTOL mode than in wing-borne flight mode. The benefit of inlet passages and vent air passages that increase in effective cross section during VTOL flight are at least two-fold— increased cooling capacity during VTOL flight, and decreased drag in wing-borne flight.

In some embodiments, heat exchanger 1007 may be an oil heat exchanger configured to cool motors 1014 and gear reduction system 1015. In such an embodiment, cooling fluid lines—such as coolant lines 1016—may transport oil between heat exchanger 1007 and any components to be cooled. Components to be cooled may include: motors 1014, gear reduction system 1015, and any other components that may be advantageous to manage the temperature of, for example motor inverters. A pump, such as pump 1017 may pump fluid through the first subsystem.

In some embodiments, the cooling system may be segmented to minimize the number of connections traversing between the tilting section of the tiltrotor system and the fixed section. Cooling system connections traversing between the tilting section and fixed section may have several disadvantages. Hoses or other connections traversing the two sections may introduce complications such as: potential for hoses to twist or buckle; increased weight due to longer and more complex hose requirements; the potential for the hoses to get damaged due to snagging or pinching; or the requirement for a potentially complex connection mechanisms. All components necessary to cool the drivetrain components that tilt may be configured tilt with the tilting section. For example, in FIG. 1, the heat exchanger and pump configured to cool the motors and gearbox are mounted to the tilting section of the rotor mounting structure. Thus, a system such as disclosed by some of the embodiments herein may advantageously limit the connections required to traverse between the tilting section and fixed section.

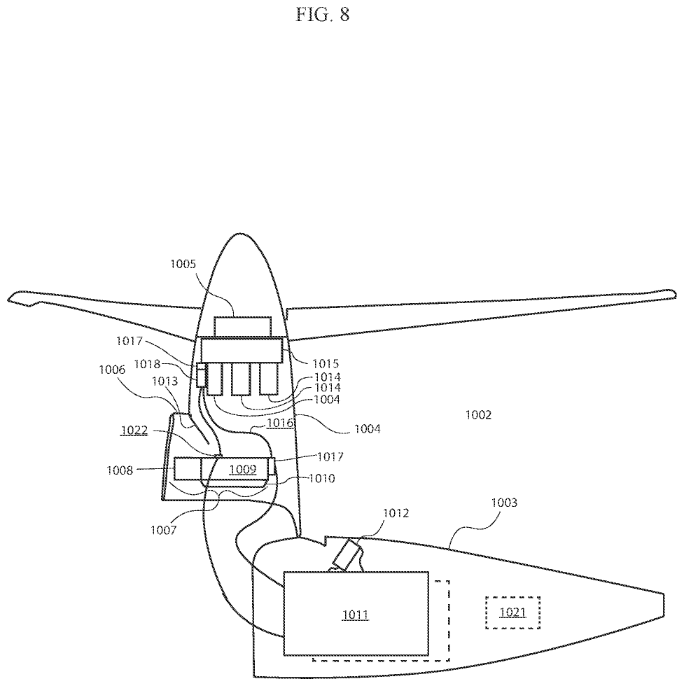

In an alternative embodiment, a heat exchanger—such as primary heat exchanger 1007 shown in FIG. 8—may be configured to use a first fluid—for example water-glycol mix—to cool batteries 1011. Pump 1017 may pump the first fluid through coolant lines 1016 to batteries 1011 or a heat sink configured to cool batteries 1011. The first cooling fluid may also circulate to liquid to liquid heat exchanger 1018 shown in FIG. 8. A second subsystem may be configured to cool a second set of components—for example motors 1014 and gear reduction system 1015 using a second fluid—for example oil. A second pump 1017 may pump the second fluid through the second set of components and through the liquid to liquid heat exchanger.

Cooling system 1001 may comprise blow in door 1013. Blow in door 1013 may be configured to be selectively opened, closed, or moved to a position between fully open or closed. When the aircraft is in forward wing-borne flight, the blow in door 1013 may be closed to reduce aerodynamic drag—illustrated in FIG. 2. During normal wing-borne flight, the tilting section 1004 and fixed section 1003 of the nacelle may be closed. In such a configuration, air—with a relatively high speed due to the forward cruise of the aircraft—may flow into cowl 1006. The air may flow through the first heat exchanger section 1008 before exiting the aircraft.

Heat exchanger 1007 may comprise a first heat exchanger section 1008 and second section 1009. The first heat exchanger section 1008 and the second heat exchanger section 1009 may be: sections of a single heat exchanger 1007; decoupling sections (sections configured such that one may be selectively by-passed by either or both fluids) of a single heat exchanger; separate heat exchangers that cumulatively make up heat exchanger 1007; or any other configuration of two heat exchanger sections. Furthermore, the first and second heat exchanger may be connected and use the same cooling fluid or may use different cooling fluid through different subsystems. For example, first heat exchanger section 1008 and the connected components may use a first fluid, and the second heat exchanger system 1009 and the components connected thereto may use a second fluid.

It should be understood that any cooling fluid may be used. Furthermore, there may be multiple cooling fluids used simultaneously, as illustrated in FIG. 1. For example, a first subsystem comprising a first and second heat exchanger section may use oil to cool the motors 1014 and gear reduction system 1015. A second cooling sub-system comprising a third heat exchanger 1012 may use a second cooling fluid, for example a water-glycol mixture to cool other components—for example batteries 1011. Fluids that may be used include, but are not limited to: water, glycol, oil, gas. Furthermore, any heat transferring medium may be used such as heat sinks.

In some embodiments, heat may be transported or dissipated using heat pipes, heat spreaders, Peltier devices or any suitable active or passive heat transfer device. For example, heat pipes may be used to transport heat from the motors to a heat exchanger.

In some embodiments, the aircraft comprises a thermal management controller 1021, illustrated in FIG. 1. Thermal management controller 1021 may be configured to control blow-in door 1013, pump 1017, valve 1022, fan assembly 1010, and other components. For example, when an aircraft—such as aircraft 3001—is in forward flight, thermal management controller 1021 may command blow-in door 1013 to close. Free stream air 1025 may flow into cowl 1006, through first heat exchanger 1008 before venting out of the aircraft. Thermal management controller 1021 may command a pump 1017 to pump a heat exchanger fluid through heat exchanger 1007 and through motors, gear reduction system 1014.

Electronic flight control system 1028 may command aircraft 3001 to transition to vertical flight and tilt the tilting section of nacelle 1002—thus creating a larger opening between tilting section 1004 and fixed section 1003. Thermal management controller 1021 may command blow-in door 1013 to open, directing air to a larger section of heat exchanger 1007. Thermal management controller 1021 may command fan assembly 1010 to pull air through heat exchanger 1009, causing air to move up around the periphery of heat exchanger 1007 before being pulled through the heat exchanger 1007 and pushed out the bottom of the tilting nacelle section.

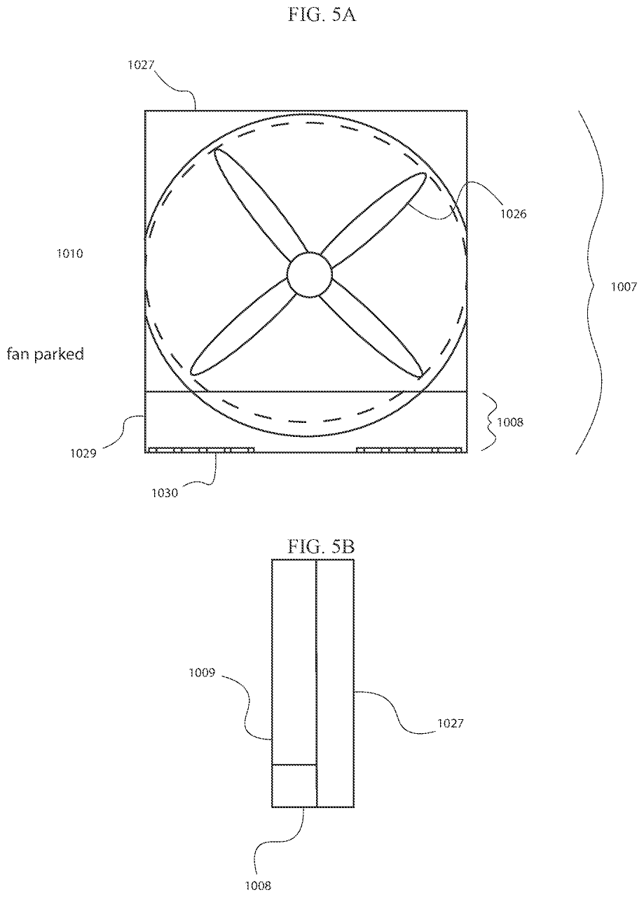

When an aircraft transitions again to forward flight, the tilting section of the nacelle or other proprotor supporting structure may tilt so that the proprotor axis of rotation is approximately parallel to the roll axis of the aircraft. As the forward velocity of the aircraft increases, the need for fan assembly 1010 to provide air movement through heat exchanger 1007 will decrease. When the free stream velocity is great enough that sufficient air is entering cowl 1006 such that first heat exchanger section 1006 may cool aircraft 3001, thermal management controller 1021 may cause power to be cut to fan assembly 1010. In some embodiments, thermal management controller 1021 may command fan assembly 1010 to stop rotating and stay in an orientation configured to prevent or minimize interference with air flow past the heat exchanger. One possible embodiment of such a fan system is illustrated in FIG. 5A and FIG. 5B. Thermal management controller 1021 may also command blow-in door 1013 to close.

Additionally, fan assembly 1010 may comprise a fan shroud 1027. Fan shroud 1027 may be configured to increase the fan's capacity to pull air through heat exchanger 1007. In some embodiments, fan shroud 1027 may contain air flaps to allow better airflow during forward flight at speed. One possible type of shroud flap may be shroud flap 1029. Shroud flap 1029 may be configured to selectively pivot towards or away from heat exchanger 1007. It may pivot up against heat exchanger 1007 to provide better seal around fan and thus increase the fan's ability to pull air through at low speeds. Alternatively, shroud flap 1029, may fold down to provide a larger cross section for air to flow through heat exchanger 1007. For example, flap 1029 may pivot about flap hinges 1030. It should be understood any other means to selectively expose more or less heat exchanger cross section around fan 1009 may be used. For example, rubber flaps that flap out of the way when air pressure pushes them open.

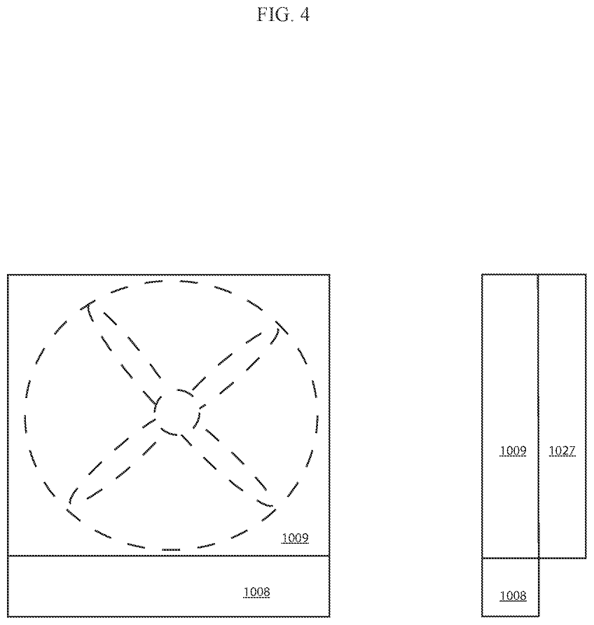

As can be seen in FIGS. 5A and 5B, in some embodiments the fan assembly 1010 may span substantially all of heat exchanger 1007. In other embodiments, the fan assembly may span only a portion of heat exchanger 1007, such as only over the second heat exchanger section 1009 as shown in FIG. 4. In some embodiments—particularly where the fan assembly 1010 spans across at least a portion of first heat exchanger section 1008 and second heat exchanger section 1009—the fan assembly may be configured to park in a position configured to minimize the airpath blockage at cruise speed. For example—as seen in FIGS. 5A and 5B—thermal management controller 1021 may command fan 1026 to park in an orientation that minimizes or eliminates the interference of fan 1026 with airflow through first heat exchanger section 1008.

Since the free stream airflow 1025—shown in FIG. 2—is relatively high and creates relative high pressure when entering cowl 1006, there is no need for a fan to assist with airflow, indeed even a fan spinning at full speed may tend to interfere with airflow during cruise speeds. However, during low aircraft airspeeds, fan 1026 is critical to generating adequate airflow through heat exchanger 1007. Thus, an embodiment in which fan assembly 1010 is configured to selectively generate airflow across at least part of both first heat exchanger section 1008 and second heat exchanger section 1007 or park such as not to obscure a cooling airpath is valuable.

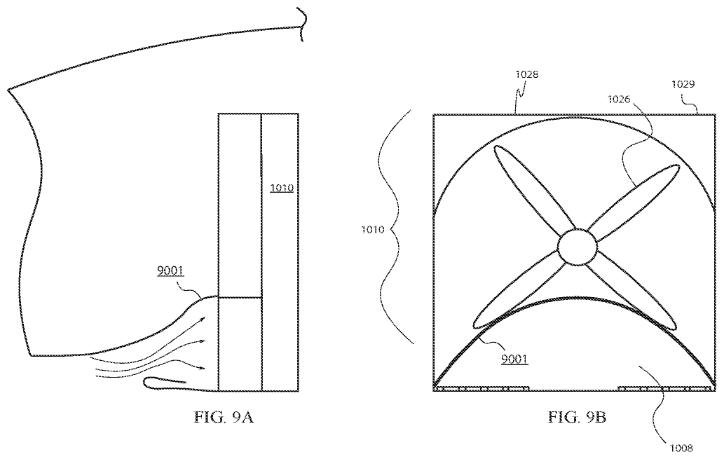

In some embodiments the air path corresponding to first heat exchanger section 1008 may be other than a quadrilateral. For example, in FIGS. 9A and 9B, the cowl may be arced as well as the corresponding heat exchanger section 1008. Such an embodiment maximizes how much unobstructed heat exchanger cross section can be obtained from a fan being parked in a certain orientation. In such an embodiment—as shown in FIG. 9B— the arced cowl 9001 arcs up on the top center such to be configured to take advantage of the heat exchanger area that is not obstructed by the parked fan.

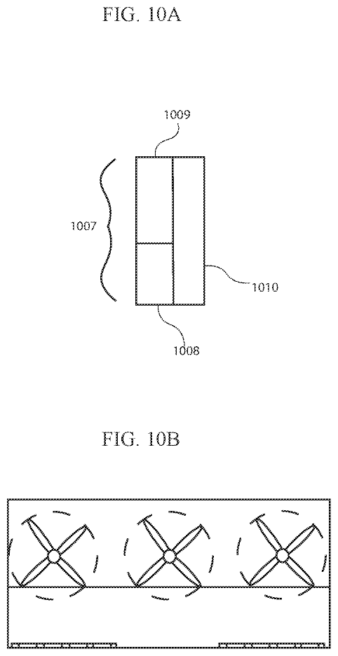

Some embodiments may have any number of fans, for example two, or three, or four, or 100. For example, in FIG. 10A, the cooling system comprises three fans configured to pull air through heat exchanger 1007. FIG. 10B illustrates a front view of such an embodiment. Additionally, other air moving devices may be used, or no fan at all. Different embodiments can comprise any size according to application.

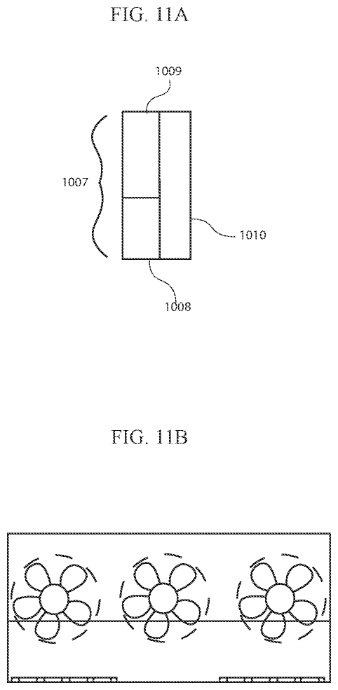

Furthermore, it should be understood that the fan or fans may be of any solidity or design. In some embodiments a high solidity fan, such as the fan embodiments shown in FIG. 11b, may be advantageous because such fans can be more efficient at moving air at low vehicle air speeds. FIG. 11A illustrates a side view of such an embodiment. In some embodiments, a relatively low solidity fan, such as the fan embodiment illustrated in FIG. 9, may have beneficial characteristics. For example, a relatively low solidity fan with four blades or fewer may result in relatively low drag during cruise. Additionally, a low solidity fan with four blades or less may be ideally configured for parking out of the way of airflow during cruise.

Other embodiments may not have a fan assembly 1010. Some applications may have sufficient air flow from other sources to achieve cooling requirements without such a fan assembly.

Some embodiments may comprise an exhaust blow in door 1023. The door may close, blocking second cowl 1019—such as shown in FIG. 2. The aircraft may be configured such that exhaust blow-in door may be configured to direct air over batteries 1011. In some embodiments the air may be used to warm batteries 1011. Thus, efficiently transferring heat from a heat shedding source to a different component that requires an increase in heat. The position of the blow in door may be controlled actively by an actuator, for example a linear actuator configured to cause blow in door to open or close. Alternatively, the blow in door's position may be controlled passively. For example, the pressure differential on the door may be used to control the position of the door. The blow-in door may comprise a stop to control the door from moving around, opening, or closing excessively.

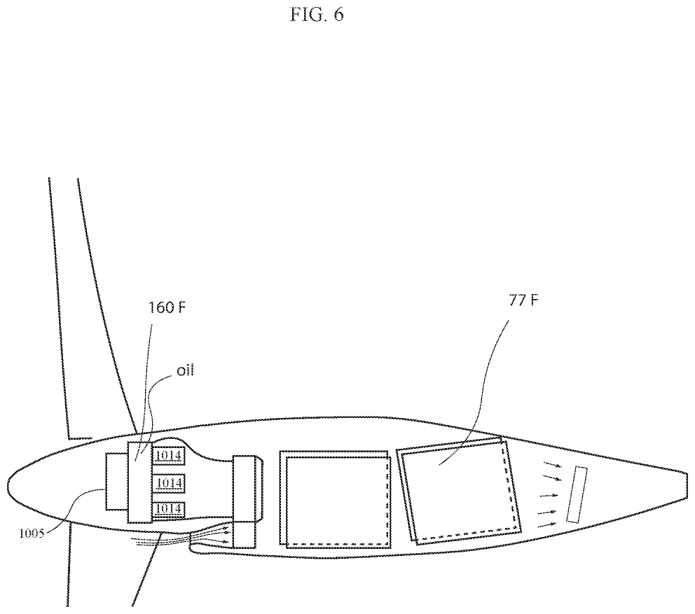

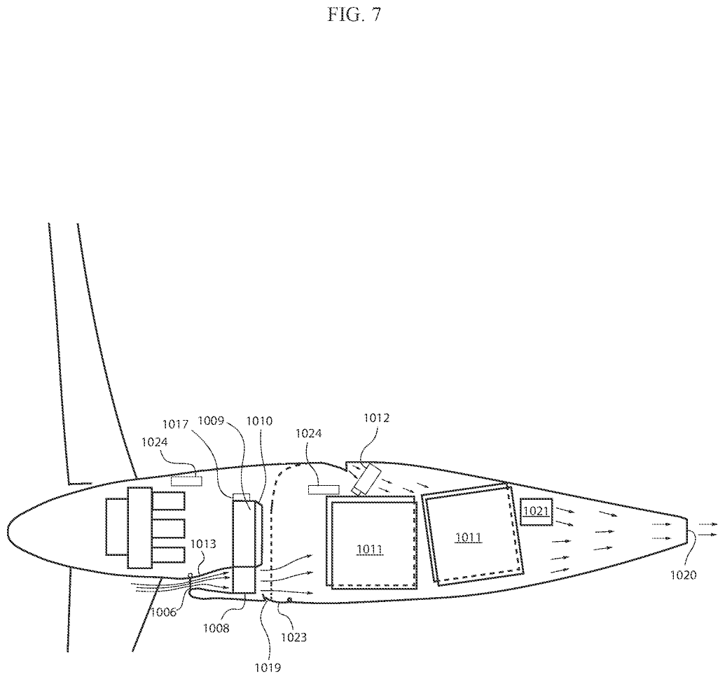

The cooling system may comprise fluid heaters configured to warm fluid to an ideal operating temperature when the ambient temperature is relatively low. For example, if the ambient temperature is 40 degrees Fahrenheit, heaters 1024—illustrated in FIG. 7— may heat cooling fluid and thus the connected components to an ideal temperature. For example, thermal management controller 1021 may command fluid heaters 1024 to warm batters 1011 to an ideal operating temperature, such as 77 degrees Fahrenheit. Thermal management controller may command heaters to heat a second group of components, for example motors 1014 and gear reduction system 1015 to an ideal temperature, for example 160 degrees Fahrenheit. FIG. 6 illustrates an embodiment configured to maintain different aircraft system components at different temperatures. It should be understood, the system could be configured to maintain system temperatures in a range about the specified temperatures.

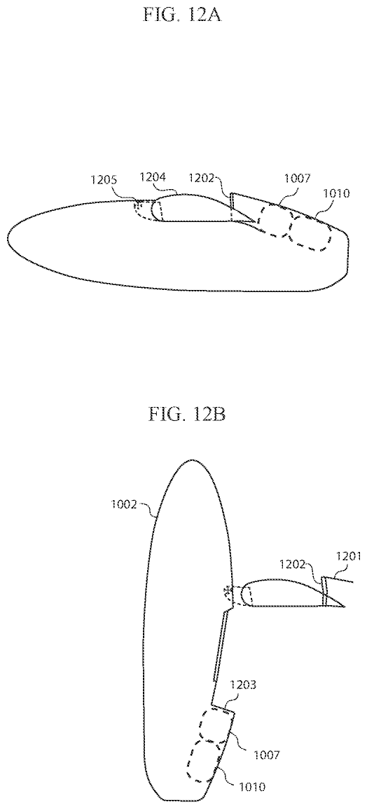

FIGS. 12A and 12B illustrate an alternative embodiment of an aircraft cooling system. The embodiment comprises: wing section 1204; wingborne flight mode duct 1201; heat exchanger 1007; fan assembly 1010; wingborne flight mode air inlet 1202; vertical flight mode inlet 1203; and wing pivot 1205. In forward flight mode, cooling air flows into wingborne flight mode duct 1201. The duct comprises a smaller cross section than the vertical flight mode inlet 1203. Thus, the spillage drag is minimized during forward flight mode. However, in vertical flight mode and in transition nacelle 1002 rotates relative to wing 1204. The wingborne flight mode duct 1201 is fixed relative to the wing. Thus, when the nacelle rotates, a larger cooling inlet—vertical flight mode duct 1201—is exposed to the outside air. The larger vertical flight mode duct 1201 is better suited to handle the cooling demands of vertical flight mode. Thus, in the embodiment of FIGS. 12A and 12B, the rotation of the nacelle from horizontal towards vertical results in the opening of a larger cooling air inlet.

While some of the material contained herein will be especially useful when applied to eVTOL, it should be understood that the principles disclosed herein are contemplated as applicable to many other applications in addition to eVTOL. For example, some concepts may be applied to gas consuming tiltrotor aircraft, rotorcraft in general, aircraft and even vehicles in general. Furthermore, some aspects, for example the orientation specific parking of the fan may be applicable to fields such as building airflow and cooling.

It should be noted that any language directed to a thermal management controller, or electronic flight controller should be read to include any suitable combination of computing devices, including servers, interfaces, systems, databases, agents, peers, engines, controllers, or other types of computing devices operating individually or collectively. The computing devices may comprise a processor configured to execute software instructions stored on a tangible, non-transitory computer readable storage medium (e.g., hard drive, solid state drive, RAM, flash, ROM, etc.). The software instructions preferably configure the computing device to provide the roles, responsibilities, or other functionality as discussed above with respect to the disclosed apparatus. In some embodiments, various servers, systems, databases, or interfaces may exchange data using standardized protocols or algorithms, possibly based on HTTP, HTTPS, AES, public-private key exchanges, web service APIs, known financial transaction protocols, or other electronic information exchanging methods. Data exchanges preferably are conducted over a packet-switched network, the Internet, LAN, WAN, VPN, or other type of packet switched network. Aspects of the thermal management controller may be located somewhere on the aircraft on which the cooling system is located or anywhere else including in a ground-based control center, on other aircraft, or even in components of the cooling system itself. Furthermore, in some embodiments the thermal management controller and the electronic flight control system may be implemented in distinguishable units or may be combined in one unit.

1. An aircraft comprising:
a first heat exchanger section;
a second heat exchanger section;
a first air inlet;
a second air inlet; and
wherein the first air inlet is configured to flow air through the first heat exchanger section and the second air inlet is configured to flow air through the second heat exchanger section, and wherein the second heat exchanger section is configured to provide a significant portion of the cooling during a first mode of flight and the second heat exchanger section is configured to provide a significant portion of cooling during a second mode of flight.

2. The aircraft of claim 1 wherein the first air inlet comprises a cowl.

3. The aircraft of claim 2 further comprising a second cowl, wherein the second cowl is configured to vent air that flows through the first cowl during wing-borne flight.

4. The aircraft of claim 3 wherein the aircraft is configured to provide sufficient cooling to the powertrain components so that the coolant temperature at the motors does not significantly exceed 160 degrees Fahrenheit and the coolant temperature at the batteries does not significantly exceed 77 degrees Fahrenheit.

5. The aircraft of claim 1 wherein the aircraft is a vertical takeoff and landing vehicle.

6. The aircraft of claim 5 wherein the aircraft is configured to provide sufficient cooling for the powertrain components during nominal VTOL flight conditions.

7. The aircraft of claim 6 wherein the aircraft comprises a tilting section configured to provide tilt to a rotor and a fixed section.

8. The aircraft of claim 7 wherein the second air inlet comprises an inlet that increases in cross section as the tilting section tilts vertically.

9. The aircraft of claim 8 wherein the aircraft is configured to maintain a cooling fluid temperature of no more than 180 degrees Fahrenheit during nominal flight conditions at maximum takeoff weight, ambient temperature of 90 degrees Fahrenheit and a pressure altitude of 4,000 feet.

10. The aircraft of claim 7 wherein the first passage is configured to flow enough air through the first heat exchanger section during wing-borne cruise to provide sufficient cooling to the components connected to a first cooling system subsystem.

11. The aircraft of claim 7 wherein the second airflow inlet is an opening at the back of a tilting nacelle shell section.

12. The aircraft of claim 11 wherein the first cooling system subsystem is configured to tilt with the tilting nacelle shell section.

13. The aircraft of 12 additionally comprising a second cooling system subsystem wherein the second cooling system subsystem is not configured to rotate with the tilting nacelle shell section.

14. The aircraft of claim 13 wherein the second cooling subsystem comprises a heat exchanger.

15. The aircraft of claim 1 further comprising a blow-in door, wherein the blow-in door is configured to selectively distribute airflow between the first and second heat exchanger section.

16. The aircraft of claim 15 comprising a first cowl and second heat exchanger section that are configured to provide sufficient cooling at a forward cruise velocity of 120 knots.

17. The aircraft of claim 16 wherein the aircraft is configured to maintain the batteries at 77 degrees Fahrenheit and the motor and gear boxes at 160 degrees Fahrenheit.

18. The aircraft of claim 17 wherein the first mode of flight is wing-borne flight at cruise speed.

19. The aircraft of claim 18 wherein the second mode of flight is VTOL flight.

20. The aircraft of claim 1 wherein the aircraft is further configured to pre-cool powertrain components before beginning flight.

21. The aircraft of claim 1 wherein the cooling system is configured to warm powertrain components to a desired temperature.

22. The aircraft of claim 1 wherein the aircraft is an electric VTOL aircraft.

23. The aircraft of claim 1 wherein the aircraft is a tiltrotor electric VTOL aircraft.

24. A cooling system comprising:
a first air passage;
a heat exchanger disposed at least partially within the first air passage.
a fan; and
a thermal management controller configured to stop the fan in an orientation configured to minimize the obstruction of airflow through the first air passage.

25. A VTOL aircraft cooling system comprising:
a heat exchanger;
cooling system air inlet paths;
cooling system air vent paths; and
wherein the cooling system is configured such that the effective cross section of the air intake paths and the effective of cross section of the vent paths increase when the aircraft transitions to rotor-borne mode from wing-borne mode.

26. The cooling system of claim 25 wherein the effective cross section of the heat exchanger is at least twice the effective cross section of the heat exchanger when the aircraft is in rotor-borne flight as opposed to wing-borne flight.

27. The cooling system of claim 25 wherein the effective cross section of the inlet and outlet paths are at least twice the effective cross section of the inlet and outlet paths when the aircraft is in rotor-borne flight as opposed to wing-borne flight.
